(19) United States
(12) Patent Application Publication
(10) Pub. No.: US 2006/0217287 A1
(43) Pub. Date: Sep. 28, 2006

(54) Fabric softening composition

(75) Inventors: Yun Peng Zhu, Fairlawn, NJ (US); Jeanette Ashley, Verona, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 11/086,011

(22) Filed: Mar. 22, 2005

(51) Int. Cl. C11D 3/00

(52) U.S. Cl. 510/515

(57) ABSTRACT

An aqueous fabric softening composition suitable for use in a wash and/or rinse cycle of automatic laundry machine, the composition comprising: (a) from about 0.5% to about 4%, by weight of the composition, of a synthetic anionic surfactant; (b) a fatty acid soap, wherein the weight ratio of the synthetic anionic surfactant to the fatty acid soap is below about 1; (c) from about 0.05% to about 2%, by weight of the composition, of a cationic quaternary cellulose ether polymer.

### FIELD OF THE INVENTION

The present invention relates to fabric softening composition which may be used along with a detergent in the wash cycle of automatic laundry machine.

### BACKGROUND OF THE INVENTION

Laundry detergents provide excellent soil removal, but can often make fabric feel harsh after washing. To combat this problem, a number of fabric conditioning technologies, including rinse-added softeners, dryer sheets, and 2-in-1 detergent softeners, have been developed. 2-in-1 detergent softener is a single product that provides both detergency and softening. The advantage of the 2-in-1 product is that it is used in the wash cycle The disadvantage of the 2-in-1 product is lack of flexibility—the detergent and the softener always have to be used together. Consumers may wish, however, to omit softening of some of the fabrics and thus may not always wish to use a 2-in-1 product. In addition, consumers may wish to have flexibility in choosing the laundry detergent product. Thus there is need for a softening product that can be used in the wash cycle, but is a stand-alone product. In other words, there is need to de-couple the laundry and softening functions, yet to have a softening product that can soften effectively in the presence of a laundry detergent.

Softening laundry detergent compositions have been disclosed in WO 2004/069979; EP 786,517; Kischkel et al. (U.S. Pat. No. 6,616,705); Kischkel et al. (U.S. Pat. No. 6,620,209); Mermelstein et al. (U.S. Pat. No. 4,844,821); Wang et al. (U.S. Pat. No. 6,833,347); Weber et al. (U.S. Pat. No. 4,289,642); WO 0/309511; Erazo-Majewicz et al. (US Patent No. 2003/0211952). Washer added fabric softening compositions have been disclosed in Caswell et al. (U.S. Pat. No. 4,913,828) and Caswell (U.S. Pat. No. 5,073,274). Fabric softener compositions have been disclosed in WO 00/70005; Cooper et al. (U.S. Pat. No. 6,492,322); Christiansen (U.S. Pat. No. 4,157,388). Cationic polymers are employed as softening actives in some of the disclosed compositions, sometimes along with anionic surfactants.

The present invention is based at least in part on the discovery that improved softening may be achieved, by adding a small amount of a synthetic anionic surfactant in a certain weight ratio to a fatty acid soap, to a softening composition containing a cationic polymer.

### SUMMARY OF THE INVENTION

An aqueous fabric softening composition suitable for use in a wash and/or rinse cycle of automatic laundry machine, the composition comprising:
(a) from about 0.5% to about 4%, by weight of the composition, of a synthetic anionic surfactant;
(b) a fatty acid soap, wherein the weight ratio of the synthetic anionic surfactant to the fatty acid soap is below about 1;
(c) from about 0.05% to about 2%, by weight of the composition, of a cationic quaternary cellulose ether polymer.

Also disclosed are concentrated compositions and methods of softening fabrics by using the compositions.

### DETAILED DESCRIPTION OF THE INVENTION

Except in the operating and comparative examples, or where otherwise explicitly indicated, all numbers in this description indicating amounts of material or conditions of reaction, physical properties of materials and/or use are to be understood as modified by the word “about.” All amounts are by weight of the liquid detergent composition, unless otherwise specified.

It should be noted that in specifying any range of concentration, any particular upper concentration can be associated with any particular lower concentration.

For the avoidance of doubt the word “comprising” is intended to mean “including” but not necessarily “consisting of” or “composed of.” In other words, the listed steps or options need not be exhaustive.

“Liquid” as used herein means that a continuous phase or predominant part of the composition is liquid and that a composition is flowable at 15° C. and above (i.e., suspended solids may be included). Gels are included in the definition of liquid compositions as used herein.

### Cationic Quaternary Cellulose Ether Polymer

A cationic polymer is here defined to include polymers which, because of their molecular weight or monomer composition, are soluble or dispersible to at least the extent of 0.01% by weight in distilled water at 25° C. Water soluble cationic polymers include polymers in which one or more of the constituent monomers are selected from the list of copolymerizable cationic or amphoteric monomers. These monomer units contain a positive charge over at least a portion of the pH range 6-11. A partial listing of monomers can be found in the “International Cosmetic Ingredient Dictionary,” 5th Edition, edited by J. A. Wenninger and G. N. McEwen, The Cosmetic, Toiletry. and Fragrance Association, 1993. Another source of such monomers can be found in “Encyclopedia of Polymers and Thickeners for Cosmetics”, by R. Y. Lochhead and W. R. Fron, Cosmetics & Toiletries, vol. 108, May 1993, pp 95-135.

The cationic polymers of the present invention can be amine salts or quaternary ammonium salts. Preferably the cationic polymers are quarternary ammonium salts. They includes cationic derivatives of natural polymers such as polysaccharide, polyquaternium 10, UCARE Polymer JR-400, UCARE Polymer LR-400, starch and their copolymers with certain cationic synthetic polymers such as polymers and co-polymers of cationic vinylpyridine or vinyl pyridinium chloride.

Specifically, monomers useful in this invention may be represented structurally as etiologically unsaturated compounds as in formula I. 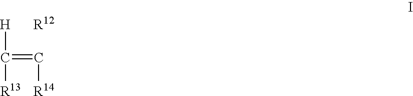
wherein R¹² is hydrogen, hydroxyl, methoxy, or a C₁ to C₃₀ straight or branched alkyl radical; R¹³ is hydrogen, or a C₁₋₃₀ straight or branched alkyl, a C₁₋₃₀ straight or branched alkyl substituted aryl, aryl substituted C₁₋₃₀ straight or branched alkyl radical, or a poly oxyalkene condensate of an aliphatic radical; and R¹⁴ is a heteroatomic alkyl or aromatic radical containing either one or more quatemerized nitrogen atoms or one or more amine groups which possess a positive charge over a portion of the pH interval pH 6 to 11. Such amine groups can be further delineated as having a pKₐ of about 6 or greater.

Examples of cationic monomers of formula I include, but are not limited to, co-poly 2-vinyl pyridine and its co-poly 2-vinyl N-alkyl quaternary pyridinium salt derivatives; co-poly 4-vinyl pyridine and its co-poly 4-vinyl N-alkyl quaternary pyridinium salt derivatives; co-poly 4-vinylbenzyltrialkylammonium salts such as co-poly 4-vinylbenzyltrimethylammonium salt; co-poly 2-vinyl piperidine and co-poly 2-vinyl piperidinium salt; co-poly 4-vinylpiperidine and co-poly 4-vinyl piperidinium salt; co-poly 3-alkyl 1-vinyl imidazolium salts such as co-poly 3-methyl 1-vinyl imidazolium salt; acrylamido and methacrylamido derivatives such as co-poly dimethyl aminopropylmethacrylamide, co-poly acrylamidopropyl trimethylammonium salt and co-poly methacrylamidopropyl trimethylammonium salt; acrylate and methacrylate derivatives such as co-poly dimethyl aminoethyl (meth)acrylate, co-poly ethanaminium N,N,N trimethyl 2-[(1-oxo-2 propenyl)oxy]-salt, co-poly ethanaminium N,N,N trimethyl 2-[(2 methyl-1-oxo-2 propenyl)oxy]-salt, and co-poly ethanaminium N,N,N ethyl dimethyl 2-[(2 methyl-1-oxo-2 propenyl)oxy]-salt.

Also included among the cationic monomers suitable for this invention are co-poly vinyl amine and co-polyvinylammonium salt; co-poly diallylamine, co-poly methyldiallylamine, and co-poly diallydimethylammonium salt; and the ionene class of internal cationic monomers. This class includes co-poly ethylene imine, co-poly ethoxylated ethylene imine and co-poly quaternized ethoxylated ethylene imine; co-poly [(dimethylimino)trimethylene(dimethylimino)hexamethylene disalt], co-poly [(diethylimino)trimethylene(dimethylimino)trimethylene disalt]; co-poly [(dimethylimino)2-hydroxypropyl salt]; co-polyquartemium-2, co-polyquartemium-17, and co-polyquartemium 18, as defined in the “International Cosmetic Ingredient Dictionary” edited by Wenninger and McEwen.

An additional, and highly preferred class of cationic monomers suitable for this invention are those arising from natural sources and include, but are not limited to, cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose;

guar 2-hydroxy-3-(trimethylammonium) propyl ether salt;

cellulose 2-hydroxyethyl 2-hydroxy 3-(trimethyl ammonio)propyl ether salt.

The counterion of the comprising cationic co-monomer is freely chosen from the halides: chloride, bromide, and iodide; or from hydroxide, phosphate, sulfate, hydrosulfate, ethyl sulfate, methyl sulfate, formate, and acetate.

The weight fraction of the cationic polymer which is composed of the above-described cationic monomer units can range from 1 to 100%, preferably from 10 to 100%, and most preferably from 15 to 80% of the entire polymer. The remaining monomer units comprising the cationic polymer are chosen from the class of anionic monomers and the class of nonionic monomers or solely from the class of nonionic monomers. In the former case, the polymer is an amphoteric polymer while in the latter case it can be a cationic polymer, provided that no amphoteric co-monomers are present. Amphoteric polymers should also be considered within the scope of this disclosure, provided that the polymer unit possesses a net positive charge at one or more points over the wash pH range of pH 6 to 11.

The class of nonionic monomers are represented by the compounds of formula IV in which none of the R^{15,} R¹⁶, or R¹⁷ contain the above mentioned negative charge containing radicals. Preferred monomers in this class include, but are not limited to, vinyl alcohol; vinyl acetate; vinyl methyl ether; vinyl ethyl ether; acrylamide, methacrylamide and other modified acrylamides; vinyl propionate; alkyl acrylates (esters of acrylic or methacrylic acid); and hydroxyalkyl acrylate esters. A second class of nonionic monomers include co-poly ethylene oxide, co-poly propylene oxide, and co-poly oxymethylene. A third, and highly preferred, class of nonionic monomers includes naturally derived materials such as hydroxyethylcellulose.

Many of the aforementioned cationic polymers can be synthesized in, and are commercially available in, a number of different molecular weights. In order to achieve optimal cleaning and softening performance from the product, it is desirable that the water-soluble cationic or amphoteric polymer used in this invention be of an appropriate molecular weight. Without wishing to be bound by theory, it is believed that polymers that are too high in mass can entrap soils and prevent them from being removed. The use of cationic polymers with an average molecular weight of less than about 850,000 daltons, and especially those with an average molecular weight of less than 500,000 daltons can help to minimize this effect without significantly reducing the softening performance of properly formulated products. On the other hand, polymers with a molecular weight of about 10,000 daltons or less are believed to be too small to give an effective softening benefit.

In addition, the charge density of the cationic polymer can affect either softening or staining removal. The charge density relates to the degree of cationic substitution, and can be expressed with Nitrogen content of a cationic polymer. Preferred are cationic polymer having a N % from 0.01 to 2.2%, and more preferred are cationic polymers having a N % from 0.2 to 1.6%, and most preferred are cationic polymers having a N % from 0.3 to 1.4%.

Synthetic Anionic Surfactant

As used herein, “synthetic anionic surfactant” excludes fatty acid salts.

Synthetic anionic surface active agents which may be used in the present invention are those surface active compounds which contain a long chain hydrocarbon hydrophobic group in their molecular structure and a hydrophilic group, i.e. water solubilizing group such as carboxylate, sulfonate or sulfate group or their corresponding acid form. It should be noted that the corresponding acid is not in and of itself a surfactant. Only neutralised, or salt, form functions as a surfactant. The synthetic anionic surfactants agents include the alkali metal (e.g. sodium and potassium) and nitrogen based bases (e.g. mono-amines and polyamines) salts of water soluble higher alkyl aryl sulfonates, alkyl sulfonates, alkyl sulfates and the alkyl poly ether sulfates. One of the preferred groups of mono-anionic surface active agents are the alkali metal, ammonium or alkanolamine salts of higher alkyl aryl sulfonates and alkali metal, ammonium or alkanolamine salts of higher alkyl sulfates or the mono-anionic polyamine salts. Preferred higher alkyl sulfates are those in which the alkyl groups contain 8 to 26 carbon atoms, preferably 12 to 22 carbon atoms and more preferably 14 to 18 carbon atoms. The alkyl group in the alkyl aryl sulfonate preferably contains 8 to 16 carbon atoms and more preferably 10 to 15 carbon atoms. A particularly preferred alkyl aryl sulfonate is the sodium, potassium or ethanolamine C₁₀ to C₁₆ benzene sulfonate, e.g. sodium linear dodecyl benzene sulfonate. The primary and secondary alkyl sulfates can be made by reacting long chain olefins with sulfites or bisulfites, e.g. sodium bisulfite. The alkyl sulfonates can also be made by reacting long chain normal paraffin hydrocarbons with sulfur dioxide and oxygen as describe in U.S. Pat. Nos. 2,503,280, 2,507,088, 3,372,188 and 3,260,741 to obtain normal or secondary higher alkyl sulfates suitable for use as surfactant detergents.

The alkyl substituent is preferably linear, i.e. normal alkyl, however, branched chain alkyl sulfonates can be employed, although they are not as good with respect to biodegradability. The alkane, i.e. alkyl, substituent may be terminally sulfonated or may be joined, for example, to the 2-carbon atom of the chain, i.e. may be a secondary sulfonate. It is understood in the art that the substituent may be joined to any carbon on the alkyl chain. The higher alkyl sulfonates can be used as the alkali metal salts, such as sodium and potassium. The preferred salts are the sodium salts. The preferred alkyl sulfonates are the C₁₀ to C₁₈ primary normal alkyl sodium and potassium sulfonates, with the C₁₀ to C₁₅ primary normal alkyl sulfonate salt being more preferred.

Mixtures of higher alkyl benzene sulfonates and higher alkyl sulfates can be used as well as mixtures of higher alkyl benzene sulfonates and higher alkyl polyether sulfates.

The higher alkyl polyethoxy sulfates used in accordance with the present invention can be normal or branched chain alkyl and contain lower alkoxy groups which can contain two or three carbon atoms. The normal higher alkyl polyether sulfates are preferred in that they have a higher degree of biodegradability than the branched chain alkyl and the lower poly alkoxy groups are preferably ethoxy groups.

The preferred higher alkyl polyethoxy sulfates used in accordance with the present invention are represented by the formula:
R¹—O(CH₂CH₂O)ₚ—SO₃M,
where R¹ is C₈ to C₂₀ alkyl, preferably C₁₀ to C₁₈ and more preferably C₁₂ to C₁₅; p is 1 to 8, preferably 2 to 6, and more preferably 2 to 4; and M is an alkali metal, such as sodium and potassium, an ammonium cation or polyamine. The sodium and potassium salts, and polyamines are preferred.

A preferred higher alkyl poly ethoxylated sulfate is the sodium salt of a triethoxy C₁₂ to C₁₅ alcohol sulfate having the formula:
C₁₂₋₁₅—O—(CH₂CH₂O)₃—SO₃Na

Examples of suitable alkyl ethoxy sulfates that can be used in accordance with the present invention are C₁₂₋₁₅ normal or primary alkyl triethoxy sulfate, sodium salt; n-decyl diethoxy sulfate, sodium salt; C₁₂ primary alkyl diethoxy sulfate, ammonium salt; C₁₂ primary alkyl triethoxy sulfate, sodium salt; C₁₅ primary alkyl tetraethoxy sulfate, sodium salt; mixed C₁₄₋₁₅ normal primary alkyl mixed tri- and tetraethoxy sulfate, sodium salt; stearyl pentaethoxy sulfate, sodium salt; and mixed C₁₀₋₁₈ normal primary alkyl triethoxy sulfate, potassium salt.

The normal alkyl ethoxy sulfates are readily biodegradable and are preferred. The alkyl poly-lower alkoxy sulfates can be used in mixtures with each other and/or in mixtures with the above discussed higher alkyl benzene, sulfonates, or alkyl sulfates.

The alkali metal higher alkyl poly ethoxy sulfate can be used with the alkylbenzene sulfonate and/or with an alkyl sulfate, in an amount of 0 to 70%, preferably 5 to 50% and more preferably 5 to 20% by weight of entire composition.

Fatty Acid Salt
R¹COOM
where R¹ is a primary or secondary alkyl group of 7 to 21 carbon atoms and M is a solubilizing cation. The alkyl group represented by R¹ may represent a mixture of chain lengths and may be saturated or unsaturated, although it is preferred that at least two thirds of the R¹ groups have a chain length of between 8 and 18 carbon atoms. Nonlimiting examples of suitable alkyl group sources include the fatty acids derived from coconut oil, tallow, tall oil and palm kernel oil. For the purposes of minimizing odor, however, it is often desirable to use primarily saturated carboxylic acids. Such materials are available from many commercial sources, such as Uniqema (Wilmington, Del.) and Twin Rivers Technologies (Quincy, Mass.).

Examples of acceptable solubilizing cations, M, for use with this invention include alkali metals such as sodium, potassium and mixtures thereof. Preferably, the inventive compositions are substantially free of amine salts, e.g. alkanolamines, such as triethanolamine and/or monoethanolamine, i.e. compositions contain less than 0.5%, preferably less than 0.1%, most preferably less than 0.05% of alkanolamines. It has been found that when alkanolamine salts of fatty acid are present, they impede the softening performance. A mixture of sodium and potassium salts is particularly preferred when the soap level is high for the purpose of product stability especially at low temperature. Although, when used, the majority of the fatty acid should be incorporated into the formulation in neutralized salt form, it is often preferable to leave a small amount of free fatty acid in the formulation, as this can aid in the maintenance of product viscosity.

Amounts

The cationic polymers of this invention are effective at surprisingly low levels. As such, the cationic polymer is typically employed in an amount of from 0.05 to 2%, preferably from 0.05 to 1%, most preferably from 0.1 to 1%, in order to maximise performance at optimum cost.

It is highly preferred, and often necessary in the case of certain compositions, to formulate the products of this invention with the proper ratio of cationic polymer to total anionic surfactant (synthetic and fatty acid salt). Too high a ratio can result in reduced softening, poor packing at the interface, unacceptable dissolution times and, in the case of liquid products, an excessively high viscosity which can render the product non-pourable, and thus unacceptable for consumer use. The use of lower ratios of cationic polymer to surfactant also reduces the overall level of polymer necessary for the formulation, which is also preferable for cost and environmental reasons, and gives the formulator greater flexibility in making a stable product. The preferred ratio of cationic polymer: total surfactant will be less than about 1:4, whereas the preferred ratio of cationic polymer: total anionic surfactant (synthetic plus fatty acid salt) will be less than about 1:5, and the preferred ratio of cationic polymer: nonionic surfactant will be less than about 1:5. More preferably, the ratios of cationic polymer: total surfactant, cationic polymer: total anionic surfactant and cationic polymer: total surfactant will be less than about 1:10.

According to the present invention, improved softening is achieved by employing the combination of a certain relatively small amount of the synthetic anionic surfactant and a certain ratio of the synthetic anionic surfactant to the fatty acid salt. The amount of the synthetic anionic surfactant is generally in the range of from 0.5 to 4%, preferably from 1 to 3%. The ratio of the synthetic anionic surfactant to the fatty acid salt is in the range is below 1, preferably in the range from 0.1 to 1, more preferably from 0.1 to 0.7, most preferably below 0.5, optimally from 0.2 to 0.5.

Amounts—Concentrated Compositions

Inventive compositions can also exist in concentrated form where synthetic anionic surfactant is present in the range of from 1% to 6.0%, and soap is from 14% to 22%, polymer is from 0.5% to 2.0%. More preferably synthetic anionic surfactant salt is less than 4.5%, soap is from 14% to 20%, and polymer is from 0.8% to 1.2% by the weight of the composition. The ratios of the ingredients are the same as described above for more dilute compositions.

Process of Making Compositions

To a certain amount of water, an electrolyte such as citrate is added to make a salt solution. To this salt solution, a polymer is slowly added while keep mixing so as to avoid formation of a gel. An alkali such as NaOH, KOH or its mixture is added to polymer solution, followed by addition of alkylbenzene sulfonic acids or another synthetic anionic. The mixture becomes hazy and turbid in the beginning. A fatty acid is then added to the mixture, and the mixture gets much clearer. After the fatty acid is fully consumed, nonionic surfactant is optionally added to the solution and the mixing is continued until the nonionic is fully dissolved in the solution. Miscellaneous ingredients are added to finish the composition. Preferably synthetic anionic is added before fatty acid to avoid the viscosity increase of the mixture.

Water

The compositions are aqueous, that is, the inventive compositions comprise generally from 20% to 99.9%, preferably from 40% to 80%, most preferably, to achieve optimum cost and ease of manufacturing, from 50% to 70% of water. Other liquid components, such as solvents, surfactants, liquid organic matters including organic bases, and their mixtures can be present.

Co-solvents that may be present include but are not limited to alcohols, surfactant, fatty alcohol ethoxylated sulfate or surfactant mixes, alkanol amine, polyamine, other polar or non-polar solvents, and mixtures thereof.

The pH of the inventive liquid compositions is generally equal to or greater than 5.0, preferably greater than 6.0, most preferably greater than 6.5. The pH of the inventive compositions is generally in the range of from 5 to 10, preferably not greater than 9.5, in order to attain maximum efficacy at a minimum cost.

Optional Ingredients

The fabric softening compositions of the present invention may include typical laundry ingredients, such as fluorescent whitening agents, enzymes, anti-redeposition agents, bleaches, etc. There is no need to do so, however, since when used in the wash cycle the inventive compositions are co-present with a separate laundry detergent composition, and so the inclusion of laundry benefit agents into the inventive compositions is redundant.

The inventive compositions may also include other fabric softening agents, in addition to the cationic polymers described above. Other cationic polymers may be present, such as polyquatemium-16, polyquatemium-46, polyquaternium-11, polyquatemium-28, polyethyleneimine and its derivatives, amidoamine quatemary-derived homopolymer and copolymer, such as polyquatemium-32 and 37, Ciba Special chemical's Salcare cationic polymers such as salcare super 7, Tinofix CL, and Rodia's Synthetic cationic polymer such as Mirapol 100, 550, A-15, WT and polycare 133. In addition, the inventive compositions may also include _hydrophobically modified cationic polysaccharides such as Crodacel QM and Crodacel QS, as well as other softening and conditioning agents, such as monoalkylquatemary ammounium salt, monoalkyl diquaternary ammounium salt, and cationic softening surfactants such as dialkyldimehtyl quaternary salt, dialkylamidoamine quaternary salts, diester quaternary salt.

The inventive compositions may include cationic and amphoteric surfactants. The inventive compositions preferably include a nonionic surfactant, in order to assure the long term stability of the composition especially at low temperature.

Nonionic Surfactant

The nonionic surfactants are characterized by the presence of a hydrophobic group and an organic hydrophilic group and are typically produced by the condensation of an organic aliphatic or alkyl aromatic hydrophobic compound with ethylene oxide (hydrophilic in nature). Typical suitable nonionic surfactants are those disclosed in U.S. Pat. Nos. 4,316,812 and 3,630,929, incorporated by reference herein.

Usually, the nonionic surfactants are polyalkoxylated lipophiles wherein the desired hydrophile-lipophile balance is obtained from addition of a hydrophilic poly-alkoxy group to a lipophilic moiety. A preferred class of nonionic detergent is the alkoxylated alkanols wherein the alkanol is of 9 to 20 carbon atoms and wherein the number of moles of alkylene oxide (of 2 or 3 carbon atoms) is from 3 to 20. Of such materials it is preferred to employ those wherein the alkanol is a fatty alcohol of 9 to 11 or 12 to 15 carbon atoms and which contain from 5 to 9 or 5 to 12 alkoxy groups per mole. Also preferred is paraffin-based alcohol (e.g. nonionics from Huntsman or Sassol).

Exemplary of such compounds are those wherein the alkanol is of 10 to 15 carbon atoms and which contain about 5 to 12 ethylene oxide groups per mole, e.g. Neodol® 25-9 and Neodolo® 23-6.5, which products are made by Shell Chemical Company, Inc. The former is a condensation product of a mixture of higher fatty alcohols averaging about 12 to 15 carbon atoms, with about 9 moles of ethylene oxide and the latter is a corresponding mixture wherein the carbon atoms content of the higher fatty alcohol is 12 to 13 and the number of ethylene oxide groups present averages about 6.5. The higher alcohols are primary alkanols.

Another subclass of alkoxylated surfactants which can be used contain a precise alkyl chain length rather than an alkyl chain distribution of the alkoxylated surfactants described above. Typically, these are referred to as narrow range alkoxylates. Examples of these include the Neodol-I(R) series of surfactants manufactured by Shell Chemical Company.

Other useful nonionics are represented by the commercially well known class of nonionics sold under the trademark Plurafac® by BASF. The Plurafacs® are the reaction products of a higher linear alcohol and a mixture of ethylene and propylene oxides, containing a mixed chain of ethylene oxide and propylene oxide, terminated by a hydroxyl group. Examples include C₁₃-C₁₅ fatty alcohol condensed with 6 moles ethylene oxide and 3 moles propylene oxide, C₁₃-C₁₅ fatty alcohol condensed with 7 moles propylene oxide and 4 moles ethylene oxide, C₁₃-C₁₅ fatty alcohol condensed with 5 moles propylene oxide and 10 moles ethylene oxide or mixtures of any of the above.

Another group of liquid nonionics are commercially available from Shell Chemical Company, Inc. under the Dobanol® or Neodol® trademark: Dobanol® 91-5 is an ethoxylated C₉-C₁₁ fatty alcohol with an average of 5 moles ethylene oxide and Dobanol® 25-7 is an ethoxylated C₁₂-C₁₅ fatty alcohol with an average of 7 moles ethylene oxide per mole of fatty alcohol.

In the compositions of this invention, preferred nonionic surfactants include the C₁₂-C₁₅ primary fatty alcohols with relatively narrow contents of ethylene oxide in the range of from about 6 to 9 moles, and the C₉ to C₁₁ , fatty alcohols ethoxylated with about 5-6 moles ethylene oxide.

Another class of nonionic surfactants which can be used in accordance with this invention are glycoside surfactants. Glycoside surfactants suitable for use in accordance with the present invention include those of the formula:
RO—(R²O)_{y}—(Z)ₓ
wherein R is a monovalent organic radical containing from about 6 to about 30 (preferably from about 8 to about 18) carbon atoms; R² is a divalent hydrocarbon radical containing from about 2 to 4 carbons atoms; O is an oxygen atom; y is a number which can have an average value of from 0 to about 12 but which is most preferably zero; Z is a moiety derived from a reducing saccharide containing 5 or 6 carbon atoms; and x is a number having an average value of from 1 to about 10 (preferably from about 1½ to about 10).

A particularly preferred group of glycoside surfactants for use in the practice of this invention includes those of the formula above in which R is a monovalent organic radical (linear or branched) containing from about 6 to about 18 (especially from about 8 to about 18) carbon atoms; y is zero; z is glucose or a moiety derived therefrom; x is a number having an average value of from 1 to about 4 (preferably from about 1½ to 4).

Nonionic surfactants which may be used include polyhydroxy amides as discussed in U.S. Pat. No. 5,312,954 to Letton et al. and aldobionamides such as disclosed in U.S. Pat. No. 5,389,279 to Au et al., both of which are hereby incorporated by reference into the subject application.

Generally, nonionics would comprise less than 15%, preferably less than 10%, more preferably less than 7% of the composition.

Mixtures of two or more of the nonionic surfactants can be used.

Builders/Electrolytes

Although builders can be included according to this invention, in the preferred embodiment compositions are substantially free, i.e comprise less than 1%, preferably less than 0.5% of builders, other than polycarboxylic acid salts—builders are not necessary in a fabric softening composition, and so compositions may be produced cheaper without builders. Na silicate and soda ash were tested in the composition, but the high alkalinity caused degradation of cationic polymer over the storage. As a result, the softening decreased after the storage. The borax should be avoided if the composition does not have a sufficient polyol such as sorbitol because the boron anions can form a complex with the guar-based cationic polymer, resulting in a poor product stability. Addition of a small amount of sodium citrate is to facilitate the dissolution of cationic polymer.

Examples of inorganic alkaline detergency builders that should preferably be excluded are water-soluble alkalimetal phosphates, polyphosphates, borates, silicates and also carbonates. Specific examples of such salts are sodium and potassium triphosphates, pyrophosphates, orthophosphates, hexametaphosphates, tetraborates, silicates and carbonates.

Examples of organic alkaline detergency builder salts that should be excluded are: (1) water-soluble amino polycarboxylates, e.g., sodium and potassium ethylenediaminetetraacetates, nitrilotriacetatesand N-(2 hydroxyethyl)-nitrilodiacetates; (2) water-soluble salts of phytic acid, e.g., sodium and potassium phytates (see U.S. Pat. No. 2,379,942); (3) water-soluble polyphosphonates, including specifically, sodium, potassium and lithium salts of ethane-1-hydroxy-1,1-diphosphonic acid; sodium, potassium and lithium salts of methylene diphosphonic acid; sodium, potassium and lithium salts of ethylene diphosphonic acid; and sodium, potassium and lithium salts of ethane-1,1,2-triphosphonic acid. Other examples include the alkali metal salts of ethane-2-carboxy-1,1-diphosphonic acid hydroxymethanediphosphonic acid, carboxyldiphosphonic acid, ethane-1-hydroxy-1,1,2-triphosphonic acid, ethane-2-hydroxy-1,1,2-triphosphonic acid, propane-1,1,3,3-tetraphosphonic acid, propane-1,1,2,3-tetraphosphonic acid, and propane-1,2,2,3-tetraphosphonic acid; (4) water-soluble salts of polycarboxylate polymers and copolymers as described in U.S. Pat. No 3,308,067.

The compositions may contain polycarboxylate builders, including water-soluble salts of mellitic acid, citric acid, and carboxymethyloxysuccinic acid, imino disuccinate, salts of polymers of itaconic acid and maleic acid, tartrate monosuccinate, tartrate disuccinate and mixtures thereof.

Also, the compositions are substantially free of zeolites or aluminosilicates, for instance an amorphous water-insoluble hydrated compound of the formula Naₓ(_{y}AlO₂.SiO₂), wherein x is a number from 1.0 to 1.2 and y is 1, said amorphous material being further characterized by a Mg++ exchange capacity of from about 50 mg eq. CaCO₃/g. and a particle diameter of from about 0.01 micron to about 5 microns. This ion exchange builder is more fully described in British Pat. No. 1,470,250.

Other materials such as clays, particularly of the water-insoluble types, may be useful adjuncts in compositions of this invention. Particularly useful is bentonite. This material is primarily montmorillonite which is a hydrated aluminum silicate in which about ⅙th of the aluminum atoms may be replaced by magnesium atoms and with which varying amounts of hydrogen, sodium, potassium, calcium, etc. may be loosely combined. The bentonite in its more purified form (i.e. free from any grit, sand, etc.) suitable for detergents contains at least 50% montmorillonite and thus its cation exchange capacity is at least about 50 to 75 meq per 100 g of bentonite. Particularly preferred bentonites are the Wyoming or Western U.S. bentonites which have been sold as Thixo-jels 1, 2, 3 and 4 by Georgia Kaolin Co. These bentonites are known to soften textiles as described in British Patent No. 401, 413 to Marriott and British Patent No. 461,221 to Marriott and Guam.

Propylene glycol may be included for low temperature stability and sometimes when a polymer premix is needed, addition of propylene glycol will help swell the polymer.

Anti-foam agents, e.g. silicon compounds, such as Silicane® L 7604, can also be added in small effective amounts, although it should be noted that the inventive compositions are low-foaming.

Bactericides, e.g. tetrachlorosalicylanilide and hexachlorophene, ftmgicides, dyes, pigments (water dispersible), preservatives, e.g. formalin, ultraviolet absorbers, anti-yellowing agents, such as sodium carboxymethyl cellulose, pH modifiers and pH buffers, color safe bleaches, perfume and dyes and bluing agents such as Iragon Blue L2D, Detergent Blue 472/572 and ultramarine blue can be used.

Also, additional soil release polymers and cationic softening agents may be used.

In addition, various other detergent and/or softening additives or adjuvants may be present in the detergent product to give it additional desired properties, either of functional or aesthetic nature.

Preferably, the composition is a colored composition packaged in the transparent/translucent (“see-through”) container. Preferred containers are transparent/translucent bottles. “Transparent” as used herein includes both transparent and translucent and means that a composition, or a package according to the invention preferably has a transmittance of more than 25%, more preferably more than 30%, most preferably more than 40%, optimally more than 50% in the visible part of the spectrum (approx. 410-800 nm). Alternatively, absorbency may be measured as less than 0.6 (approximately equivalent to 25% transmitting) or by having transmittance greater than 25% wherein % transmittance equals: 1/10^{absorbancy}×100%. For purposes of the invention, as long as one wavelength in the visible light range has greater than 25% transmittance, it is considered to be transparent/translucent.

Transparent bottle materials with which this invention may be used include, but are not limited to: polypropylene (PP), polyethylene (PE), polycarbonate (PC), polyamides (PA) and/or polyethylene terephthalate (PETE), polyvinylchloride (PVC); and polystyrene (PS).

The preferred liquid inventive compositions which are packaged into transparent containers include an opacifier to impart a pleasing appearance to the product. The inclusion of the opacifier is particularly beneficial when the liquid detergent compositions in the transparent containers are in colored. The preferred opacifier is styrene/acrylic co-polymer. The opacifier is employed in amount of from 0.0001 to 1%, preferably from 0.0001 to 0.2%, most preferably from 0.0001 to 0.04%.

The container of the present invention may be of any form or size suitable for storing and packaging liquids for household use. For example, the container may have any size but usually the container will have a maximal capacity of 0.05 to 15 L, preferably, 0.1 to 5 L, more preferably from 0.2 to 2.5 L. Preferably, the container is suitable for easy handling. For example the container may have handle or a part with such dimensions to allow easy lifting or carrying the container with one hand. The container preferably has a means suitable for pouring the liquid detergent composition and means for reclosing the container. The pouring means may be of any size of form but, preferably will be wide enough for convenient dosing the liquid detergent composition. The closing means may be of any form or size but usually will be screwed or clicked on the container to close the container. The closing means may be cap which can be detached from the container. Alternatively, the cap can still be attached to the container, whether the container is open or closed. The closing means may also be incorporated in the container.

Method of Using Compositions

The compositions are particularly useful for convenient use in a wash cycle of laundry operation. The compositions may, however, also be used in the rinse cycle (in addiotion to the wash cycle or solely in the rinse cycle). In use, the indicated quantity of the composition (generally in the range from 30 to 200 ml or 30 g to 200 grams) depending on the actives of the composition depending on the size of the laundry load, the size and type of the washing machine, is added to the washing machine which also contains water and the soiled laundry (and in the case of the wash cycle, a laundry detergent).

Benefits

The compositions of this invention are intended to confer conditioning benefits to garments, home textiles, carpets and other fibrous or fiber-derived articles. These formulations are not to be limited to conditioning benefits, however, and will often be multi-functional.

The primary conditioning benefit afforded by these products is softening. Softening includes, but is not limited to, an improvement in the handling of a garment treated with the compositions of this invention relative to that of an article laundered under identical conditions but without the use of this invention. Consumers will often describe an article that is softened as “silky” or “fluffy”, and generally prefer the feel of treated garments to those that are unsoftened.

The conditioning benefits of these compositions are not limited to softening, however. They may, depending on the particular embodiment of the invention selected, also provide an antistatic benefit. In addition to softening, the cationic polymer/anionic surfactant compositions of this invention are further believed to lubricate the fibers of textile articles, which can reduce wear, pilling and color fading, and provide a shape-retention benefit. This lubricating layer may also, without wishing to be bound by theory, provide a substrate on the fabric for retaining fragrances and other benefit agents. Furthermore, the cationic polymers of this invention are also believed to inhibit the transfer, bleeding and loss of vagrant dyes from fabrics during the wash, further improving color brightness over time.

The following specific examples further illustrate the invention, but the invention is not limited thereto.

### EXAMPLE 1 AND COMPARATIVE EXAMPLE A

This example illustrates the criticality of the ratio of synthetic anionic surfactant (LAS salt) to soap (coco salt), by comparing Example 1 (within the scope of the invention) to Example A (outside the scope of the invention).

Fabric was washed with 120 g commercially available laundry detergent (“all”®), with the addition of 80 g of test fabric softening composition at the start of wash. For each of the washes, the tested composition was added to a top loading washing machine that contained about 86 liters of water and 2.7 Kg of fabric together with the laundry detergent. The fabric consisted of several 86% cotton/14% polyester hand towels and 100% cotton sheets. The temperature of the water for the washes was 32° C. and the fabric was washed for 12 minutes, followed by a single rinse. The fabrics were then dried in a tumble dryer. Two washes were done with each product. Each formula tested is benchmarked against a control. For the control, 120 g of Final Touch® fabric softener, was added at the beginning of the rinse cycle.

At least five panelists scored the softness of the hand towels on a 0-10 scale with 0 being “not soft at all” and 10 being “extremely soft”. Duplicate panels were run based on the duplicate washes and the scores were averaged over the two runs. For the Control run, the softness score was 5.7.

The results that were obtained are summarized in Table 1.

TABLE 1

(Active based
on 100%)

| Ingredients | 1 | A |
|---|---|---|
| Polymer LR400* | 0.75 | 0.75 |
| Propylene Glycol | 1.0 | 1.0 |
| NaOH | 1.05 | 1.05 |
| LAS acid** | 3.00 | 5.00 |
| Coco Acid | 4.00 | 2.00 |
| Alcohol Ethoxylate | 5.00 | 5.00 |
| Miscellaneous | q.s. | q.s. |
| Water | To 100 | To 100 |
| LAS Salt | 3.21 | 5.35 |
| Coco Soap | 4.43 | 2.21 |
| LAS Salt/Coco soap | 0.72 | 2.42 |
| Softness Score | 6.9 | 4.6 |
| % softness relative to | 121% | 81% |
| control | | |

*Polyquaternium 10 from Amerchol Corporation (Edison, New Jersey)
**Linear alkyl benzene sulfonic acid

It can be seen from the results in Table 1, that Example 1, within the scope of the invention, exhibited substantially improved softening relative to control, whereas Example A, outside the scope of the invention, impeded softening. The substantial improvement for Example 1 is surprising since Example 1 softened in the presence of the detergent in the wash cycle.

### EXAMPLE 2 AND COMPARATIVE EXAMPLE B

The softening performance of Example 2 (within the scope of the invention) containing LAS salt, was compared to Example B (outside the scope of the invention) without LAS salt.

The same washing/softening procedure was followed as in Example 1. Different evaluation procedure was used: Softness and preference were evaluated by the paired comparison method. 1 is very soft, 2 is soft, 3 is fair, 4 is harsh, 5 is very harsh. The lower the score, the higher the softness. 16 comparative pairs (1 treatment/16 repetitions) were tested for the examples. 10 panelists examined the pairs, and each pair was examined by 5 panelists, and then another pair was examined by another 5 panelists. Repeatedly, the other comparative pairs were examined in the same way as described above. Therefore, for 16 comparative pairs, a total of 80 observation was made with softness score and preference. Final Touch® fabric softener (used in the rinse cycle) was used as a control. The formulations that were tested and the results obtained are summarised in Tables 2 and 2A.

TABLE 2

(Active based
on 100%)

| Ingredients | B | 2 |
|---|---|---|
| Polymer LR400 | 0.75 | 0.75 |
| Propylene Glycol | 1.0 | 1.0 |
| NaOH | 0.87 | 1.14 |
| LAS acid | 0.00 | 2.00 |
| Coco Acid | 5.00 | 5.00 |
| Alcohol Ethoxylate | 5.00 | 5.00 |
| Miscellaneous | q.s. | q.s. |
| Water | To 100.00 | To 100.00 |
| Soap | 5.53 | 5.53 |
| LAS salt | 0.00 | 2.14 |
| LAS salt/soap | 0.00 | 0.39 |

TABLE 2A

| Tested composition | Softness score | Preference* | LAS salt/soap |
|---|---|---|---|
| Control | 2.0 | 37 | N/A |
| Example B | 2.2 | 3 | 0 |
| Control | 2.02 | 35 | N/A |
| Example 2 | 2.06 | 34 | 0.39 |

*number of comparisons that were in favor of this particular formulation (out of 40 pairs maximum)

The results in Table 2 demonstrate that Example 2 containing LAS salt performed as well as control, whereas Example B, which contained all the same ingredients but not LAS, performed substantially worse.

### EXAMPLES 3-4 AND COMPARATIVE EXAMPLE C

The softening performance of Examples 3-4 (both within the scope of the invention) containing LAS salt was compared to Example C (outside the scope of the invention) lacking LAS. The washing conditions and softening evaluation procedures followed were the same as in Example 1 (0 is the least soft, 10 is the most soft). The results that were obtained are summarised in Table 3.

TABLE 3

| | 3 | 4 | C |
|---|---|---|---|
| Ingredient | Weight % | Weight % | Weight % |
| Sodium Citrate | 0.30 | 0.30 | 0.30 |
| Polymer LR400 | 0.50 | 0.50 | 0.50 |
| NaOH | 1.39 | 1.00 | 1.08 |
| KOH | 0.70 | 0.70 | 0.70 |
| LAS acid | 2.50 | 2.50 | 0.00 |
| Coco Acid | 9.00 | 7.00 | 9.00 |
| Alcohol Ethoxylate | 5.80 | 5.80 | 5.80 |
| Miscellaneous | q.s. | q.s. | q.s. |
| Water | To 100.0 | To 100.0 | To 100.0 |
| Soap | 10.11 | 7.88 | 10.11 |
| LAS salt | 2.67 | 2.67 | 0.00 |
| LAS salt/soap | 0.26 | 0.34 | 0.00 |
| Softness Score | 7.8 | 8.3 | 7.1 |
| % softness relative | 93% | 99% | 85% |
| to control | | | |

The control used was Ultra Snuggle® liquid fabric softener, (used in the rinse cycle) and its softening score was 8.4. The score for Tide Deep Clean® was only 3.6.

The results in Table 3 illustrate that the addition of LAS salt substantially enhanced the softening performance.

### EXAMPLES 5-6

Examples 5-6 (both within the scope of the invention) tested formulations having different LAS salt/soap levels but having the same soap and polymer amounts. The washing conditions and softening evaluation were as described in Example 1, except that Tide Deep Clean® liquid detergent was used at a dosage of 98.6 g. The formulations and results are summarised in Table 4. The score 0 is the least soft, and the score 10 is the most soft.

TABLE 4

| | 5 | 6 |
|---|---|---|
| Ingredient | Weight % | Weight % |
| Sodium Citrate | 0.35 | 0.35 |
| Polymer LR400 | 0.50 | 0.50 |
| NaOH | 0.87 | 0.87 |
| KOH | 0.70 | 0.61 |
| LAS acid | 1.50 | 1.00 |
| Coco Acid | 7.00 | 7.00 |
| Alcohol Ethoxylate | 5.80 | 5.80 |
| Miscellaneous | q.s. | q.s. |
| Water | To 100.0 | To 100.0 |
| Soap | 7.88 | 7.85 |
| LAS salt | 1.60 | 1.07 |
| LAS salt/soap | 0.20 | 0.14 |
| Softness Score | 7.3 | 6.6 |
| % softness relative to | 90% | 81% |
| control | | |

The control used was Ultra Snuggle® liquid fabric softener (used in the rinse cycle), and its softening score was 8.1. The score for Tide Deep Cleans only was 3.2.

The results in Table 4 demonstrate that there is an optimum ratio range of LAS salt to soap to attain the best softening performance, especially in the presence of a laundry detergent in the main wash cycle.

### EXAMPLES 7-9

Examples 7-9 (all within the scope of the invention) investigated the softening performance of compositions containing various ratios of LAS salt to soap. The washing conditions and softening evaluation was conducted as described in Example 1, except that Tide Deep Clean® liquid detergent was used at a dosage of 98.6 g and the composition was used at a dosage of 100 g. The formulations and the results that were obtained are summarised in Table 5.

TABLE 5

| | 7 | 8 | 9 |
|---|---|---|---|
| Ingredient | Weight % | Weight % | Weight % |
| Sodium Citrate | 0.3 | 0.3 | 0.3 |
| Polymer LR400 | 0.4 | 0.4 | 0.4 |
| NaOH | 1.95 | 1.69 | 2.20 |
| KOH | 0 | 0 | 0 |
| LAS acid | 3.00 | 1.00 | 2.00 |
| Coco Acid | 9.00 | 9.00 | 10.00 |
| Alcohol ethoxylate | 4.00 | 3.00 | 3.50 |
| Miscellaneous | q.s. | q.s. | q.s. |
| Water | To 100 | To 100 | To 100 |
| Soap | 9.90 | 9.90 | 11.12 |
| LAS salt | 3.21 | 1.07 | 2.14 |
| LAS salt/soap | 0.32 | 0.11 | 0.19 |
| Softness Score | 6.9 | 6.7 | 7.5 |
| % softness relative | 91% | 88% | 99% |
| to control | | | |

Liquid Ultra Snuggle® fabric softener (control, used in the rinse cycle) had a softening score of 7.6, and Tide Deep Clean® detergent only had a softening score of 2.8.

The results in Table 5 demonstrate that there is an optimum ratio range of LAS salt to soap to attain the best softening performance, especially in the presence of a laundry detergent in the main wash cycle.

### EXAMPLES 10-11 AND COMPARATIVE EXAMPLE D

The softening performance of Examples 10-11 (within the scope of the invention) was compared to Example D (outside the scope of the invention), lacking synthetic anionic surfactant). Washing conditions and softening evaluation were as in Example 1. The formulating and the results that were obtained are summarised in Table 6.

TABLE 6

| | D | 10 | 11 |
|---|---|---|---|
| Ingredient | Weight % | Weight % | Weight % |
| Sodium Citrate | 0.5 | 0.5 | 0.5 |
| Polymer LR400 | 0.4 | 0.4 | 0.4 |
| NaOH | 1.39 | 1.63 | 1.76 |
| LAS acid | 0 | 3 | 4 |
| Coco Acid | 8 | 7 | 7 |
| Alcohol Ethoxylate | 5 | 5 | 5 |
| Miscellaneous | q.s. | q.s. | q.s. |
| Water | To 100 | To 100 | To 100 |
| Soap | 8.80 | 7.72 | 7.72 |
| LAS salt | 0.00 | 3.21 | 4.28 |
| Las salt/soap | 0.00 | 0.42 | 0.55 |
| Softness score | 6.1 | 6.6 | 6.6 |
| % softness relative | 77% | 84% | 84% |
| to control | | | |

Ultra Snuggle® liquid fabric softener (control, used in the rinse cycle) had a softness score of 7.9, and “all” Free Clear® liquid detergent had a softness score of 3.3.

### EXAMPLE 12 AND COMPARATIVE EXAMPLE E

The softening performance of Example 12 (within the scope of the invention) was compared to the performance of Example E (outside the scope of the invention) which did not contain any soap. The washing and softening evaluation procedures were as in Example 7. The formulations that were tested and the results that were obtained are summarised in Table 7.

TABLE 7

| | E | 12 |
|---|---|---|
| Ingredient | Weight % | Weight % |
| Sodium Citrate | 0.35 | 0.35 |
| Polymer LR400 | 0.6 | 0.6 |
| NaOH | 0.73 | 0.87 |
| KOH | 0.70 | 0.70 |
| LAS acid | 8.50 | 1.50 |
| Coco Acid | 0 | 7.00 |
| Alcohol ethoxylate | 5.00 | 5.00 |
| Miscellaneous | q.s. | q.s. |
| Water | To 100 | To 100 |
| Soap | 0 | 7.88 |
| LAS salt | 9.29 | 1.60 |
| LAS salt/soap | N/A | 0.20 |
| Softness Score | 4.3 | 7.0 |

The control was washed with Tide Deep Clean® liquid detergent only, and its softness 5 score was 2.8.

It can be seen from the results in Table 7 that in the absence of soap, even in the presence of the synthetic anionic surfactant, the softening performance of Example E was substantially lower than the performance of Example 12.

What is claimed is:

1. An aqueous fabric softening composition suitable for use in a wash and/or rinse cycle of automatic laundry machine, the composition comprising:
(a) from about 0.5% to about 4%, by weight of the composition, of a synthetic anionic surfactant;
(b) a fatty acid soap, wherein the weight ratio of the synthetic anionic surfactant to the fatty acid soap is below about 1;
(c) from about 0.05% to about 2%, by weight of the composition, of a cationic quaternary cellulose ether polymer.

2. The composition of claim 1, wherein the composition is substantially free of amines.

3. The composition of claim 1, wherein the weight ratio is in the range of from 0.2 to 1.

4. The composition of claim 1, wherein the synthetic anionic surfactant is selected from the group consisting of alkylbenzene sulfonates, alkyl sulfates, and mixtures thereof.

5. The composition of claim 1, wherein the fatty acid soap is present in an amount of at least about 2% and the soap is a mixture of sodium and potassium salts.

6. The composition of claim 1, wherein the composition further comprises from 1 to 10% of nonionic surfactant.

7. The composition of claim 1, wherein the weight ratio is in the range of from 0.2 to 0.5.

8. An aqueous concentrated fabric softening composition suitable for use in a wash and/or rinse cycle of automatic laundry machine, the composition comprising:
(a) from about 1% to about 6%, by weight of the composition, of a synthetic anionic surfactant;
(b) from about 14 to about 22% of a fatty acid soap, wherein the weight ratio of the synthetic anionic surfactant to the fatty acid soap is below about 1;
(c) from about 0.5% to about 2%, by weight of the composition, of a cationic quaternary cellulose ether polymer.

9. A method of softening and conditioning fabrics by adding the composition of claim 1 to the wash cycle and/or rinse cycle of the automatic laundry machine.
